(19) United States
(12) Patent Application Publication
(10) Pub. No.: US 2026/0216983 A1
(43) Pub. Date: Jul. 30, 2026

(54) BI-DIRECTIONAL AUGER FOR AN ACCUMULATOR ASSEMBLY

(71) Applicants: CNH Industrial America LLC, New Holland, PA (US); CNH Industrial Belgium N.V., Zedelgem (BE)

(72) Inventors: Brian Patrick Crow, Andalusia, IL (US); Rogelio Chovet, De Pinte (BE); Nicholas Shane, Rock Island, IL (US); Jordan Beckhusen, McGregor, TX (US)

(21) Appl. No.: 19/041,886

(22) Filed: Jan. 30, 2025

(51) Int. Cl. B30B 9/30; A01D 46/08

(52) U.S. Cl. CPC B30B 9/3064; A01D 46/084; A01D 46/085; B30B 9/3007; B30B 9/3014

(57) ABSTRACT

In certain embodiments, an accumulator assembly includes an accumulator having a front wall and a rear wall. The accumulator receives agricultural product from a header via an inlet portion of the accumulator. The accumulator assembly also includes at least one auger disposed within the accumulator and extending longitudinally between the front wall and the rear wall of the accumulator. Furthermore, the accumulator assembly includes at least one motor configured to drive the at least one auger to rotate. Additionally, the accumulator assembly includes a controller communicatively coupled to the at least one motor. The controller controls the at least one motor to drive the at least one auger to rotate in a first direction while the accumulator is being filled and controls the at least one motor to drive the at least one auger to rotate in a second direction, opposite the first direction, while the accumulator is being unloaded.

### BACKGROUND

The present disclosure relates generally to a bi-directional auger for an accumulator assembly of an agricultural harvester.

Agricultural harvesters are used to harvest agricultural products (e.g., cotton or other natural material(s)). For example, an agricultural harvester may include a header having row units configured to harvest the agricultural product from a field. The agricultural harvester may also include an air-assisted conveying system configured to move the agricultural product from the row units to an accumulator assembly. The agricultural product may then be fed into a baler via a conveying system. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale.

Augers may be included in the accumulator assembly to facilitate the distribution of the agricultural product within an accumulator of the accumulator assembly. Generally, augers are arranged laterally within the accumulator to laterally distribute the agricultural product.

### SUMMARY

In certain embodiments, an accumulator assembly of an agricultural harvester includes an accumulator having a front wall, a rear wall, and a pair of side walls. The accumulator is configured to receive agricultural product from a header of the agricultural harvester via an inlet portion of the accumulator. The accumulator assembly also includes at least one auger disposed within the accumulator and extending longitudinally between the front wall and the rear wall of the accumulator. Furthermore, the accumulator assembly includes at least one motor configured to drive the at least one auger to rotate. In addition, the accumulator assembly includes a controller communicatively coupled to the at least one motor. The controller is configured to control the at least one motor to drive the at least one auger to rotate in a first direction while the accumulator is being filled and to control the at least one motor to drive the at least one auger to rotate in a second direction, opposite the first direction, while the accumulator is being unloaded.

In certain embodiments, an accumulator assembly of an agricultural harvester includes an accumulator configured to receive agricultural product from a header of the agricultural harvester via an inlet portion of the accumulator and having a front wall, a rear wall, and a pair of side walls. The accumulator assembly also includes at least one auger having flighting disposed within the accumulator and extending longitudinally between the front wall and the rear wall of the accumulator. Furthermore, the accumulator assembly includes at least one motor configured to drive the at least one auger to rotate. In addition, the accumulator assembly includes a plurality of conveying rollers positioned at a bottom of the accumulator, oriented at an angle, and configured to convey the agricultural product toward a conveying system. The at least one auger is positioned above the plurality of conveying rollers and oriented at the angle of the plurality of conveying rollers. Lastly, the accumulator assembly includes a controller communicatively coupled to the at least one motor. The controller is configured to control the at least one motor to drive the at least one auger to rotate in a first direction while the accumulator is being filled and to control the at least one motor to drive the at least one auger to rotate in a second direction, opposite the first direction, while the accumulator is being unloaded.

In certain embodiments, a control system for an accumulator assembly includes a controller including a processor and a memory. The controller is configured to control a first motor to drive a first auger to rotate in a respective first direction while an accumulator of the accumulator assembly is being filled and to rotate in a respective second direction, opposite the respective first direction, while the accumulator is being unloaded and to control a second motor to drive a second auger to rotate in a respective first direction while the accumulator is being filled and to rotate in a respective second direction, opposite the respective first direction, while the accumulator is being unloaded. The controller is further configured to control the first and second motors independently of one another.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural machine system having an agricultural product transport assembly and a baler;

FIG. 2 is a schematic view of an embodiment of an agricultural product transport assembly and an embodiment of a baler that may be employed within the agricultural machine system of FIG. 1;

FIG. 3 is a cross-sectional side view of an embodiment of an accumulator assembly that may be employed within the agricultural product transport assembly of FIG. 2;

FIG. 4 is a top view of the accumulator assembly of FIG. 3;

FIG. 5 is a cross-sectional front view of the accumulator assembly of FIG. 3;

FIG. 6 is a rear view of an embodiment of a motor and a drive shaft that may be employed within the accumulator assembly of FIG. 3; and

FIG. 7 is a block diagram of an embodiment of a control system that may be employed within the accumulator assembly of FIG. 3.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

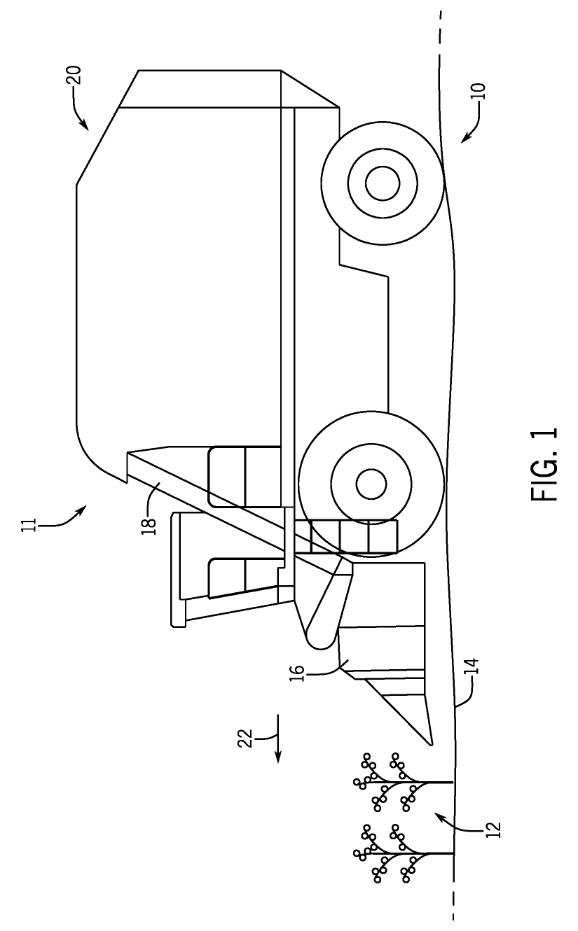

FIG. 1 is a side view of an embodiment of an agricultural machine system 10 (e.g., harvester, agricultural harvester) having an agricultural product transport assembly 11 and a baler. The agricultural machine system 10 is configured to harvest agricultural product 12 (e.g., cotton) from a field 14 and to form the agricultural product 12 into bales (e.g., agricultural bales). In the illustrated embodiment, the agricultural machine system 10 includes a header 16 having row units configured to harvest the agricultural product 12 from the field 14. Additionally, the agricultural product transport assembly 11 of the agricultural machine system 10 includes an air-assisted conveying system 18 configured to move the agricultural product 12 from the row units of the header 16 to an accumulator of the agricultural product transport assembly 11. The agricultural product transport assembly 11 also includes a conveying system configured to convey the agricultural product 12 from the accumulator into the baler 20 (e.g., agricultural baler). The baler 20 is supported by and/or mounted within or on a chassis of the agricultural machine system 10. The baler 20 may form the agricultural product 12 into round bales. However, in other embodiments, the baler 20 of the agricultural machine system 10 may form the agricultural product into square bales, polygonal bales, or bales of other suitable shape(s). After forming the agricultural product 12 into a bale, a bale wrapping system of the agricultural machine system 10 wraps the bale with a bale wrap to secure the agricultural product 12 within the bale and to generally maintain a shape of the bale.

The accumulator is part of an accumulator assembly, and the accumulator is configured to receive the agricultural product 12 from the header 16 of the agricultural machine system 10 via an inlet portion of the accumulator. The accumulator includes a front wall and a rear wall. In addition, the accumulator assembly includes an auger disposed within the accumulator and extending longitudinally along the accumulator. The accumulator assembly also includes a motor configured to drive the auger to rotate. Furthermore, the accumulator assembly includes a controller communicatively coupled to the motor, in which the controller includes a processor and a memory. The controller is configured to control the motor to drive the auger to rotate in a first direction while the accumulator is being filled and to rotate in a second direction, opposite the first direction, while the accumulator is being unloaded. In certain embodiments, the accumulator assembly also includes multiple conveying rollers positioned at a bottom of the accumulator. The conveying rollers are configured to convey the agricultural product toward the conveying system.

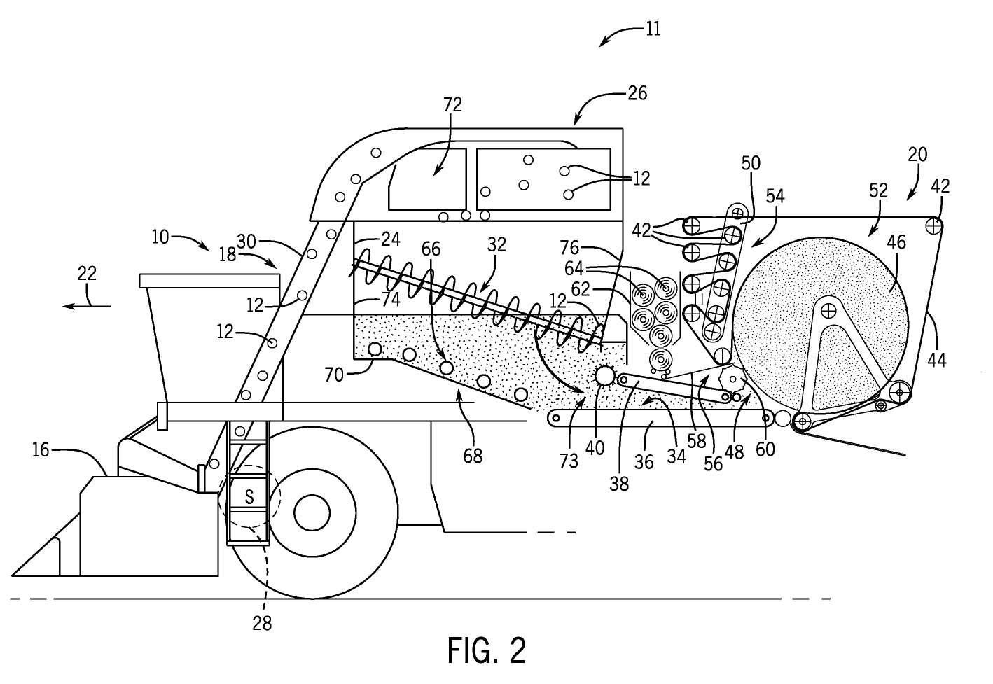

FIG. 2 is a schematic view of an embodiment of an agricultural product transport assembly 11 and an embodiment of a baler 20 that may be employed within the agricultural machine system 10 of FIG. 1. As previously discussed, the header 16 of the agricultural machine system 10 includes row units configured to harvest the agricultural product 12 (e.g., cotton) from the field. Furthermore, the air-assisted conveying system 18 is configured to move the agricultural product 12 from the row units of the header 16 to an accumulator 24 of an accumulator assembly 26. In the illustrated embodiment, the air-assisted conveying system 18 includes a conveying air source 28 configured to output a conveying air flow through one or more ducts 30. Each duct 30 receives the agricultural product 12 (e.g., cotton) from the header 16, and the conveying air flow output by the conveying air source 28 drives the agricultural product to move through the duct(s) 30 from the header 16 to the accumulator 24 of the accumulator assembly 26.

In the illustrated embodiment, the accumulator assembly 26 includes an auger 32 extending longitudinally along the accumulator 24 (e.g., from a front wall of the accumulator to a rear wall of the accumulator). The auger 32 is configured to control distribution of the agricultural product 12 (e.g., cotton) within the accumulator 24 and to move the agricultural product 12 downwardly (e.g., to facilitate movement of the agricultural product 12 toward the conveying system 34). In the illustrated embodiment, the accumulator assembly 26 includes a single auger 32, which is the only auger disposed within the accumulator 24. However, in other embodiments, the accumulator assembly may include more augers (e.g., 2, 3, 4, or more).

In the illustrated embodiment, the conveying system 34 (e.g., feeding system) of the agricultural product transport system 11 includes a first belt 36 configured to move the agricultural product 12 from the accumulator 24 to the baler 20. The first belt 36 is configured to rotate in a first rotational direction to move an agricultural product engaging surface of the first belt 36 toward the baler 20. Furthermore, in the illustrated embodiment, the conveying system 34 includes a second belt 38 positioned on an opposite side of the agricultural product 12 from the first belt 36, and the second belt 38 is configured to cooperate with the first belt 36 to move the agricultural product 12 from the accumulator 24 to the baler 20. Furthermore, in the illustrated embodiment, the conveying system 34 includes an agitation roller 40 (e.g., beater roller) positioned upstream of the second belt 38. The agitation roller 40 is configured to agitate the agricultural product 12 entering the pair of opposing belts, thereby enhancing the uniformity of the distribution of the agricultural product passing through the pair of opposing belts. While the conveying system 34 includes one agitation roller 40 in the illustrated embodiment, in other embodiments, the conveying system may include two or more agitation rollers, or the agitation roller may be omitted.

In the illustrated embodiment, the baler 20 includes multiple rollers 42 (e.g., five rollers) that support and/or drive rotation of one or more belts 44. For example, one or more rollers 42 engage the belt(s) 44, which enable the belt(s) 44 to move along the pathway defined by the rollers 42 and the bale 46. One or more rollers 42 are driven to rotate via a belt drive system (e.g., including electric motor(s), hydraulic motor(s), pneumatic motor(s), etc.). The belt(s) 44 circulate around the pathway defined by the rollers 42 and the bale 46. Movement of the belt(s) 44 captures agricultural product 12 from the conveying system 34 and draws the agricultural product 12 into a cavity 48, where the agricultural product 12 is gradually built up to form the bale 46.

In the illustrated embodiment, the baler 20 includes a tension arm 50 (e.g., take-up assembly) configured to establish tension within the belt(s) 44. As the agricultural product 12 builds within the cavity 48, the agricultural product 12 applies a force to the belt(s) 44 that urges a first portion 52 of the belt(s) 44 surrounding the bale 46 to expand. Concurrently, the size of a second portion 54 (e.g., serpentine portion) of the belt(s) 44 is reduced. Accordingly, the second portion 54 of the belt(s) 44 provides the increasing belt length for the expanding first portion 52. In the illustrated embodiment, the second portion 54 of the belt(s) 44 is established by fixed rollers 42 (e.g., rollers fixed to a housing/frame of the baler 20) and rollers 42 coupled to the tension arm 50, which is pivotable relative to the fixed rollers 42 (e.g., relative to the housing/frame of the baler 20). Accordingly, as the agricultural product 12 builds within the cavity 48, the tension arm 50 is driven to rotate, thereby reducing the size of the second portion 54 and enabling the first portion 52 to expand.

Once the bale 46 reaches a desired size, a bale wrapping system 56 wraps the bale 46 with a bale wrap 58 to secure the agricultural product within the bale 46 and to generally maintain a shape of the bale 46, such as the round shape in the illustrated embodiment The bale wrap 58 may be fed into contact with the bale 46 using one or more feed rollers. The feed rollers drive the bale wrap 58 toward a starter roller 60 (e.g., which is configured to initiate formation of the core of the bale 46). The starter roller 60 is configured to rotate to drive the bale wrap 58 into contact with the bale 46. The bale wrap 58 is captured between the bale 46 and the belt(s) 44. Accordingly, rotation of the bale 46 draws the bale wrap 58 around the bale 46, thereby wrapping the bale 46. After the bale 46 is wrapped, the bale 46 is ejected from the baler 20, and the process of forming a subsequent bale may be initiated.

In certain embodiments, during the harvesting process, the conveying system 34 and the baler 20 may be periodically activated to transfer the agricultural product 12 from the accumulator 24 to the baler 20 and to form the bale 46. For example, as the agricultural machine system 10 traverses a field, the agricultural product 12 may accumulate within the accumulator 24 (e.g., during an accumulator filling process). After a selected duration, the conveying system 34 may be activated to transfer the agricultural product 12 from the accumulator 24 to the baler 20 (e.g., during an accumulator unloading process). For example, the conveying system 34 may move the agricultural product 12 toward the baler 20 at a significantly faster rate than the air-assisted conveying system 18 moves the agricultural product 12 into the accumulator 24. Concurrently with activation of the conveying system 34, the baler 20 may be activated to initiate the bale forming process, as described above. After another selected duration, the conveying system 34 and the baler 20 may be deactivated to enable the accumulator 24 to collect additional agricultural product 12. In certain embodiments, the conveying system 34 and the baler 20 may be activated four or five times to enable the bale 46 to reach the desired size. As previously discussed, once the bale reaches the desired size, the bale wrapping system 56 wraps the bale 46 with the bale wrap 58. Because the conveying system 34 and the baler 20 are periodically activated, the agricultural machine system 10 may utilize less energy during the harvesting process (e.g., as compared to continuously operating the conveying system and the baler).

In the illustrated embodiment, the agricultural machine system 10 includes a bale wrap assembly storage compartment 62 configured to store multiple bale wrap assemblies 64. In certain embodiments, each bale wrap assembly 64 includes a shaft and a bale wrap disposed about the shaft to form a roll of the bale wrap. However, in other embodiments, the shaft may be omitted, and the bale wrap may be arranged in a roll (e.g., with a hollow region at the center). The bale wrap assembly storage compartment 62 is configured to sequentially provide each bale wrap assembly 64 to the bale wrapping system 56, thereby enabling the bale wrapping system 56 to wrap the bale 46. While the agricultural machine system 10 includes the bale wrap assembly storage compartment 62 in the illustrated embodiment, in other embodiments, the bale wrap assembly storage compartment may be omitted (e.g., the bale wrapping system may store a single bale wrap assembly).

In the illustrated embodiment, the accumulator assembly 26 includes multiple conveying rollers 66 (e.g., meter rollers) positioned at a bottom 68 of the accumulator 24. The conveying rollers 66 are configured to convey the agricultural product 12 toward the conveying system 34 (e.g., toward the agitation roller 40 of the conveying system 34). In addition, the accumulator 24 includes a floor 70 having a flat portion and an angled portion. Furthermore, in the illustrated embodiment, the accumulator 24 includes an inlet portion 72 configured to receive the agricultural product 12 from the header 16 via the air-assisted conveying system 18. The accumulator 24 also includes a front wall 74 and a rear wall 76. The accumulator 24 also includes an outlet portion 73 configured to facilitate movement of the agricultural product 12 to the conveying system 34.

The accumulator assembly 26 also includes a controller configured to control the rotation of the auger 32 to facilitate distribution and movement of the agricultural product 12. While the accumulator 24 is being filled, the auger 32 rotates in a first direction (e.g., in the clockwise direction as viewed from the rear wall 76 of the accumulator 24) such that the agricultural product 12 is more evenly distributed within the accumulator 24. As a consequence of the more even distribution of the agricultural product 12 in the accumulator 24, the compression of agricultural product may be optimized, thereby creating more uniform layers of agricultural product 12 for more efficient packaging. While the accumulator 24 is being unloaded, the auger 32 rotates in a second direction (e.g., in the counterclockwise direction as viewed from the rear wall 76 of the accumulator 24) such that the agricultural product is moved toward the outlet portion 73 of the accumulator 24. As such, the auger 32 improves the efficiency of the unloading process.

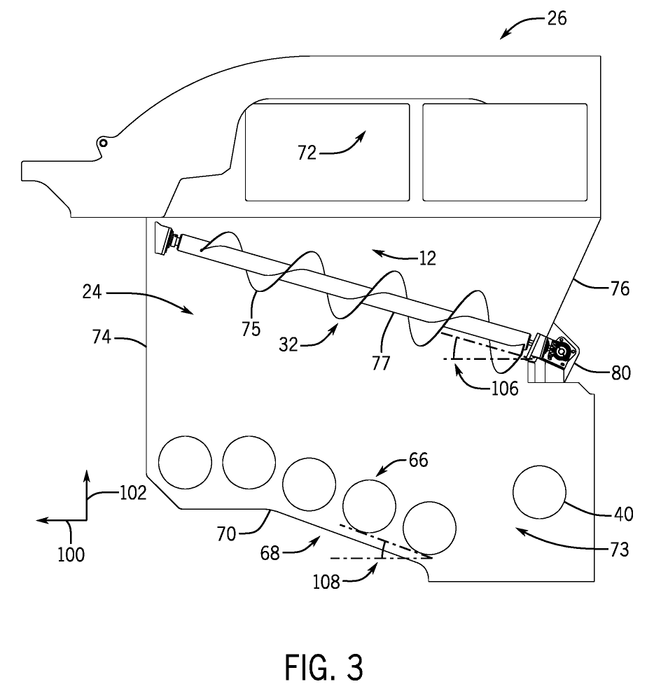

FIG. 3 is a cross-sectional side view of an embodiment of the accumulator assembly 26 that may be employed within the agricultural product transport assembly 11 of FIG. 2. In the illustrated embodiment, the accumulator assembly 26 includes an accumulator 24, at least one auger 32 disposed within the accumulator 24, and conveying rollers 66 disposed along the bottom 68 of the accumulator 24. As discussed herein, the agricultural product 12 may enter the accumulator 24 via the inlet portion 72 and be directed via the auger 32 and the conveying rollers 66 towards the outlet portion 73.

Each auger 32 includes an auger shaft 75 and flighting 77 extending along the auger shaft 75. The accumulator assembly 26 also includes a motor 80 configured to drive the auger 32 to rotate. The auger 32 is disposed within the accumulator 24 and extends longitudinally along the accumulator 24. The auger 32 is configured to distribute the agricultural product 12 longitudinally (e.g., in the longitudinal direction 100) across the accumulator 24 and to direct the agricultural product 12 toward the outlet portion 73 of the accumulator 24. The auger 32 extends longitudinally between the front wall 74 and the rear wall 76. As used herein with regard to extension of the auger, “between” refers to partial or complete extension between the front and rear walls, such that the auger may engage the front wall or the auger may not engage the front wall, and the auger may engage the rear wall or the auger may not engage the rear wall. In the illustrated embodiment, the auger 32 is rotatably coupled to the front wall 74 of the accumulator 24 and to the rear wall 76 of the accumulator 24. Furthermore, in the illustrated embodiment, the auger 32 is oriented at an angle 106 with respect to a longitudinal axis 100 of the accumulator. The angle 106 may be an acute angle with respect to the longitudinal axis 100. In some embodiments, the auger 32 is oriented parallel to the angled portion of the conveying rollers 66 such that the auger 32 is at the same angle 106 as the angle 108 of the conveying rollers 66. In some embodiments, the auger 32 may be at an angle 106 different from the angle 108 of the conveying rollers 66. Furthermore, in certain embodiments, the auger 32 may be parallel to the longitudinal axis 100.

The controller of the accumulator assembly 26 is configured to control the motor 80 to drive the auger 32 to rotate in a first direction while the accumulator 24 is being filled (e.g., the agricultural product 12 is entering the accumulator 24 via the inlet portion 72). Rotation of the auger 32 in the first direction may drive the agricultural product 12 forward, thereby improving distribution of agricultural product 12 within the accumulator 24. For example, the air-assisted conveying system may drive the agricultural product 12 to move through the inlet portion 72 of the accumulator 24 toward the rear wall 76. Rotation of the auger 32 in the first direction may convey the agricultural product 12 toward the front wall 74 of the accumulator 24, thereby enhancing the longitudinal distribution of the agricultural product 12 within the accumulator 24. Accordingly, more agricultural product 12 may be added to the accumulator 24 before the agricultural product 12 is unloaded by the conveying system. Additionally, the enhanced longitudinal distribution of the agricultural product 12 may result in less compression of the agricultural product 12, which may enhance the efficiency of the baling process. The controller may control the motor 80 to drive the auger 32 to rotate in the first direction until the level of agricultural product 12 in the accumulator 24 triggers an upper-level sensor in the accumulator 24 (e.g., the level of agricultural product 12 in the accumulator 24 exceeds a high threshold level).

In addition, the controller of the accumulator assembly 26 may control the motor 80 to drive the auger 32 to rotate in a second direction, opposite the first direction, while the accumulator is being unloaded (e.g., the agricultural product 12 is exiting the accumulator 24 via the outlet portion 73). Rotation of the auger 32 in the second direction drives the agricultural product toward the outlet portion 73, thereby improving the efficiency of the unloading process. For example, rotation of the auger 32 in the second direction, in conjunction with the conveying rollers 66, may convey the agricultural product 12 toward the outlet portion 73 of the accumulator 24, thus hastening the process of unloading the agricultural product 12 from the accumulator 24. The controller may control the motor 80 to drive the auger 32 to rotate in the second direction until the level of agricultural product in the accumulator 24 triggers a low-level sensor in the accumulator 24 (i.e., the level of agricultural product 12 in the accumulator 24 falls below a low threshold level).

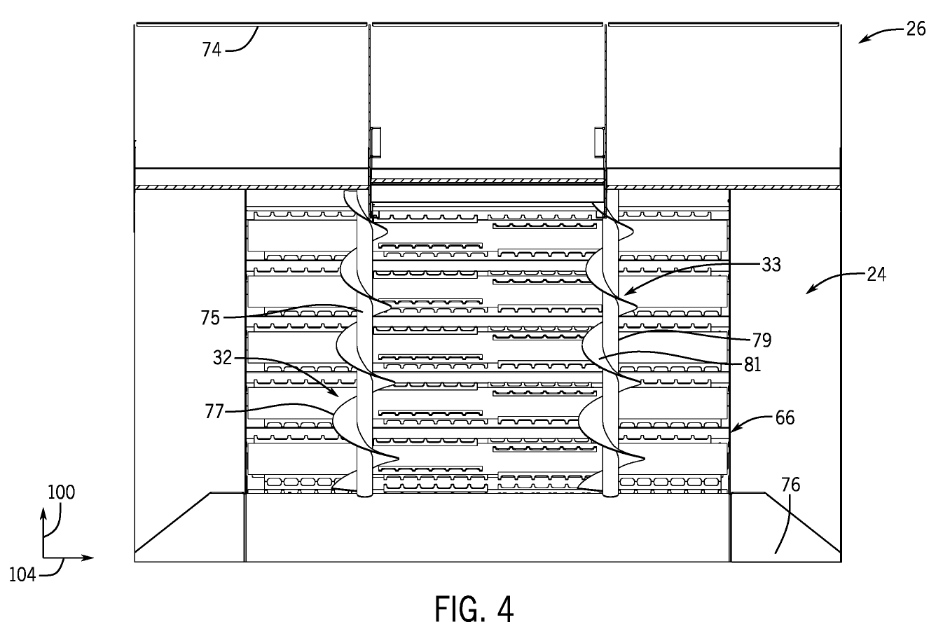

FIG. 4 is a top view of the accumulator assembly of FIG. 3. In the illustrated embodiment, the accumulator assembly 26 includes a first auger 32 and a second auger 33. While the accumulator 24 includes two augers in the illustrated embodiment, in other embodiments, the accumulator 24 may have one auger or three or more augers. The first auger 32 and the second auger 33 (collectively, “the augers”) extend longitudinally (e.g., in the longitudinal direction 100) across the accumulator 24. In some embodiments, the augers may be spaced evenly across a lateral axis 104 of the accumulator 24, as depicted in FIG. 4. In some embodiments, the augers may be placed closer together to address a particular area of accumulation of agricultural product 12. In some embodiments, the augers may be angled in the lateral direction 104. For example, the first auger 32 and the second auger 33 may converge or diverge along the longitudinal direction 100. In some embodiments, the first auger 32 and the second auger 33 may converge as the augers extend toward the front wall 74 of the accumulator 24. In other embodiments, the first auger 32 and the second auger 33 may converge as the augers extend toward the rear wall 76 of the accumulator 24.

In some embodiments, the first auger 32 and the second auger 33 may be controlled together (e.g., the first and second augers may be driven by a single motor). In other embodiments, the first auger 32 and the second auger 33 may be controlled independently (e.g., each auger may be driven by a respective independently controllable motor). In some embodiments, one auger may be driven to rotate while the accumulator 24 is being filled, and the other auger may be driven to rotate while the accumulator 24 is being emptied.

The first auger 32 includes a first auger shaft 75 and first flighting 77 extending along the first auger shaft 75; and the second auger 33 includes a second auger shaft 79 and second flighting 81 extending along the second auger shaft 79. In some embodiments, the first flighting 77 may be clockwise flighting, and the second flighting 81 may be counterclockwise flighting. In such embodiments, the respective first directions of the augers (e.g., direction of rotation during filling) may be opposite directions, and the respective second directions of the augers (e.g., direction of rotation during unloading) may be opposite directions, such that the first auger 32 and the second auger 33 convey the agricultural product 12 in the same direction.

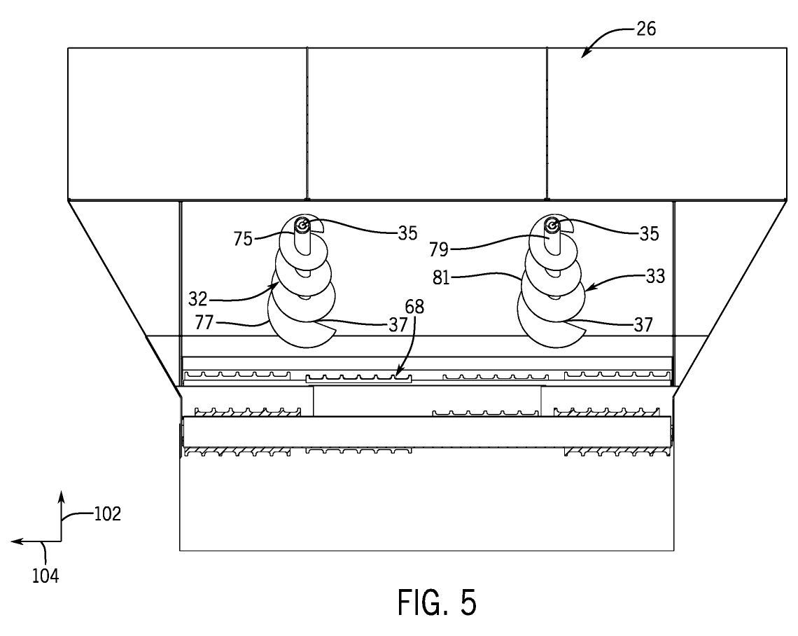

FIG. 5 is a cross-sectional front view of the accumulator assembly of FIG. 3. As previously discussed, the accumulator assembly 26 includes the accumulator 24, a first auger 32, a second auger 33, and conveying rollers. The augers extend longitudinally along the accumulator 24. The augers each include a front end 35 and a rear end 37. The augers also each include an auger shaft 75, 79 and flighting 77, 81 extending along the auger shaft 75, 79.

In the illustrated embodiment, the flighting of each auger is tapered along the auger shaft. For example, in the illustrated embodiment, the flighting at the front end 35 of each auger has a smaller diameter than the flighting at the rear end 37 of the auger. As such, the auger has larger diameter flighting at the rear end 35 to accommodate the extra agricultural product 12 at the rear portion of the accumulator and better disperse the agricultural product throughout the accumulator 24. In some embodiments, the flighting may increase in diameter continuously from the front end 35 of the auger to the rear end 37 of the auger. In other embodiments, the flighting may increase in diameter in one or more discreet increments from the front end 35 of the auger to the rear end 37 of the auger. In some embodiments, the flighting at the rear end 37 of each auger may have a smaller diameter than the flighting at the front end 35 of the auger. In some embodiments, the flighting may be a constant diameter across the auger. In the illustrated embodiment, the flighting extends continuously along the auger shaft. However, in some embodiments, the flighting may extend non-continuously along the auger shaft. In the illustrated embodiment, the flighting has a constant pitch. However, in some embodiments, a pitch of the flighting may be variable along the auger shaft. In some embodiments, the auger may include a packing paddle in between the flighting at the front end 35 and the flighting at the rear end 37 of the auger.

In some embodiments, each auger may include two or more sectional pieces attached together. The sectional pieces may each include a sectional piece shaft and flighting extending along the sectional piece shaft. A first sectional piece and a second sectional piece may be attached along a common axis to create the auger. The sectional pieces may each have a different flighting diameter such that, when attached, the flighting of the sectional pieces establish tapered flighting. In certain embodiments, the first sectional piece may include clockwise flighting and the second sectional piece may include counterclockwise flighting. In such embodiments, while the first sectional piece is rotating in the first direction, the second sectional piece may rotate in the second direction, and while the first sectional piece is rotating in the second direction, the second sectional piece may rotate in the first direction, such that the first sectional piece and the second sectional piece are conveying the agricultural product in the same direction.

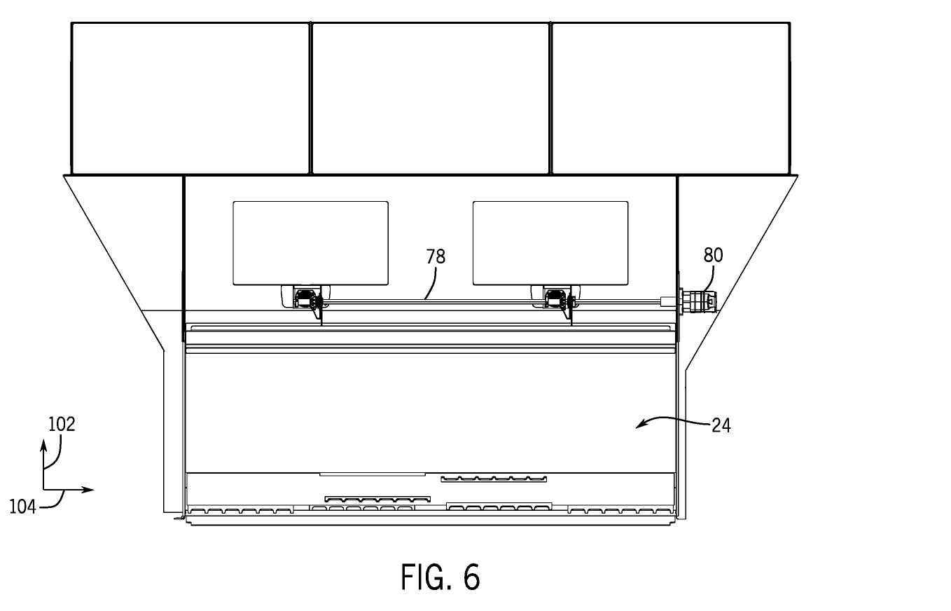

FIG. 6 is a rear view of an embodiment of the motor 80 and a drive shaft 78 that may be employed within the accumulator assembly of FIG. 3. In the illustrated embodiment, the motor 80 drives the drive shaft 78 to rotate the first auger 32 and the second auger 33. In some embodiments, the motor 80 and the drive shaft 78 may be mounted outside of the accumulator 24. The drive shaft 78 may be coupled to both the first auger 32 and the second auger 33 via respective gear assemblies (e.g., including bevel gears, etc.) such that the first auger 32 and the second auger 33 rotate together. While the first and second augers are driven to rotate by a single motor in the illustrated embodiment, in other embodiments, the first and second augers may each be driven to rotate by a respective motor.

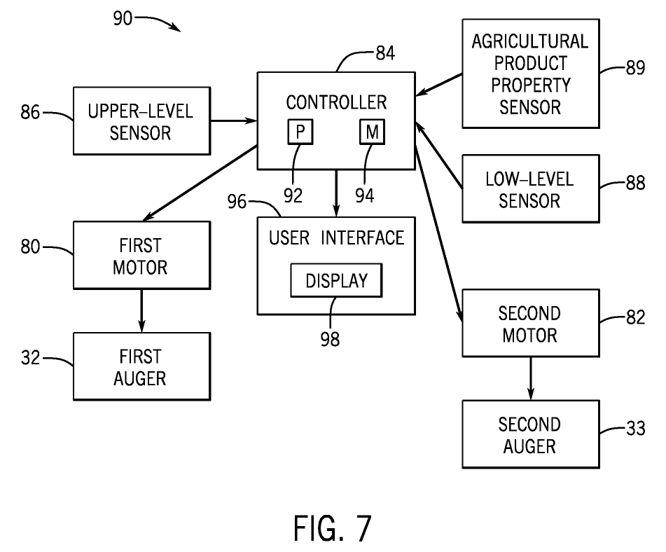

FIG. 7 is a block diagram of an embodiment of a control system 90 that may be employed within the accumulator assembly of FIG. 3. The control system 90 of the accumulator assembly includes a controller 84 configured to control rotation of the augers. In the illustrated embodiment, the control system 90 includes a first motor 80 configured to drive the first auger 32 to rotate and a second motor 82 configured to drive the second auger 33 to rotate. The first motor 80 may be coupled to a first drive shaft configured to drive the rotation of the first auger 32. The second motor 82 may be coupled to a second drive shaft configured to drive the rotation of the second auger 33. In some embodiments, the controller 84 may control the first motor 80 and the second motor 82 (collectively, “the motors”) independently. For example, the controller 84 may operate only the first motor 80 if more agricultural product 12 is accumulating along the rear end of the first auger 32 than along the rear end of the second auger 33.

In some embodiments, the controller 84 controls the first motor 80 to drive the first auger 32 to rotate in a respective first direction while the accumulator is being filled and to rotate in a respective second direction, opposite the respective first direction, while the accumulator is being unloaded. In addition, in some embodiments, the controller 84 controls the second motor 82 to drive the second auger 33 to rotate in a respective first direction while the accumulator is being filled and to rotate in a respective second direction, opposite the respective first direction, while the accumulator is being unloaded.

In some embodiments, the controller 84 may control the motors to drive the augers to rotate in respective first directions while the accumulator is being filled. When the accumulation of agricultural product reaches a threshold level (e.g., the accumulator is 90% filled), the controller 84 may control the motors to drive the augers to rotate in respective second directions, opposite the respective first directions, while the accumulator continues to be filled. Consequently, the augers may pack the agricultural product to improve the efficiency of the baling process. As the accumulator is unloaded, the controller 84 may control the motors to drive the augers to rotate in the second direction to assist in the unloading process.

In the illustrated embodiment, the controller 84 is communicatively coupled to the first motor 80 and to the second motor 82. In certain embodiments, the controller 84 is an electronic controller having electrical circuitry configured to control the motors. In the illustrated embodiment, the controller 84 includes a processor 92, such as the illustrated microprocessor, and a memory device 94. The controller 84 may also include one or more storage devices and/or other suitable components. The processor 92 may be used to execute software, such as software for controlling the motors, and so forth. Moreover, the processor 92 may include multiple microprocessors, one or more “general-purpose” microprocessors, one or more special-purpose microprocessors, and/or one or more application specific integrated circuits (ASICs), or some combination thereof. For example, the processor 92 may include one or more reduced instruction set (RISC) processors.

The memory device 94 may include a volatile memory, such as random access memory (RAM), and/or a nonvolatile memory, such as read-only memory (ROM). The memory device 94 may store a variety of information and may be used for various purposes. For example, the memory device 94 may store processor-executable instructions (e.g., firmware or software) for the processor 92 to execute, such as instructions for controlling the motors, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the motors, etc.), and any other suitable data.

In the illustrated embodiment, the control system 90 includes a user interface 96 communicatively coupled to the controller 84. The user interface 96 is configured to receive input from an operator and to provide information to the operator. The user interface 96 may include any suitable input device(s) for receiving input, such as a keyboard, a mouse, button(s), switch(es), knob(s), other suitable input device(s), or a combination thereof. In addition, the user interface 96 may include any suitable output device(s) for presenting information to the operator, such as speaker(s), indicator light(s), other suitable output device(s), or a combination thereof. In the illustrated embodiment, the user interface 96 includes a display 98 configured to present visual information to the operator. In certain embodiments, the display 98 may include a touchscreen interface configured to receive input from the operator.

In the illustrated embodiment, the controller 84 is communicatively coupled to multiple sensors of the control system 90. The sensors include the upper-level sensor 86, the low-level sensor 88, and agricultural product property sensor(s) 89, such as a humidity sensor, an optical sensor, a temperature sensor, an infrared sensor, etc. Furthermore, in certain embodiments, the sensors may include a pressure sensor coupled to the flighting of each auger and configured to output a sensor signal indicative of the amount and/or the density of the agricultural product being conveyed by the auger. Each sensor provides feedback to the controller 84 (e.g., via a respective sensor signal). The controller 84 may adjust the operation of the motors based on the sensor feedback. For example, the controller 84 may control the motor 80 to drive the auger 32 to rotate in the first direction until the upper-level sensor 86 outputs a sensor signal indicative of the level of agricultural product in the accumulator exceeding an upper-level. In response to receiving the sensor signal indicative of the agricultural product exceeding the upper-level, the controller 84 may control the motor 80 to drive the auger 32 to rotate in the second direction, thereby compressing the agricultural product within the accumulator. Furthermore, in response to receiving a sensor signal from the low-level sensor 88 indicative of the agricultural product being below a low-level, the controller 84 may control the motor 80 to drive the auger to rotate in the first direction or terminate rotation of the auger.

In some embodiments, the controller 84 operates only the first motor 80 if more agricultural product is accumulating along the first auger 32 than along the second auger 33. For example, the controller 84 may determine whether to operate the motors based on the accumulation along a front portion, a rear portion, or the entirety of the augers. The controller 84 may determine whether agricultural product is accumulated along the first auger 32, the second auger 33, or both based on the sensor signal(s). For example, a pressure sensor at the first auger 32 may measure high pressure, indicating a high accumulation of agricultural product along the first auger 32. Concurrently, a pressure sensor at the second auger 33 may measure low pressure, indicating a low accumulation of agricultural product along the second auger 33. If the controller 84 determines that the accumulation of agricultural product along the first auger 32 exceeds a threshold, the controller 84 may operate the first motor 80. In addition, if the controller 84 determines the accumulation of agricultural product along the second auger 33 does not exceed the threshold, the controller may not operate the second motor 82.

In certain embodiments, the controller 84 is configured to adjust a speed of the rotation of each auger. In some embodiments, the controller 84 may be configured to adjust the speed of the rotation of each auger based on the amount and distribution of agricultural product in the accumulator. As such, in some embodiments, a first upper-level sensor may be positioned to monitor the accumulation of agricultural product along the front wall of the accumulator, and a second upper-level sensor may be positioned to monitor the accumulation of agricultural product along the rear wall of the accumulator. For example, the controller 84 may increase the speed of the rotation of each auger to convey the agricultural product toward the front wall of the accumulator in response to the controller 84 detecting via the second upper-level sensor a large accumulation of agricultural product near the rear wall of the accumulator. As another example, the controller 84 may increase the speed of the rotation of each auger as the level of agricultural product in the accumulator increases. In some embodiments, the controller 84 may be configured to adjust the speed of the rotation of each auger based on one or more properties of the agricultural product within the accumulator. For example, in response to determining the agricultural product has a high moisture content (e.g., based on feedback from a moisture sensor of the agricultural product property sensor(s)), the controller 84 may control each motor to increase the speed of the rotation of the respective auger. As another example, in response to determining the agricultural product has high density (e.g., based on feedback from the pressure sensor of the agricultural property sensor(s)), the controller 84 may control each motor to increase the speed of rotation of the respective auger. The controller 84 may be configured to adjust the speed of the rotation of each auger individually. For example, the controller 84 may control the first motor 80 to drive the first auger 32 to rotate at a higher speed, and the controller 84 may control the second motor 82 to drive the second auger 33 to rotate at a lower speed in response to determining more agricultural product is accumulating along the rear end of the first auger 32 than along the rear end of the second auger 33.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function)…” or “step for (perform)ing (a function)…”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. An accumulator assembly for an agricultural harvester, comprising:
an accumulator configured to receive agricultural product from a header of the agricultural harvester via an inlet portion of the accumulator, wherein the accumulator comprises a front wall, a rear wall, and a pair of side walls;
at least one auger disposed within the accumulator and extending longitudinally between the front wall and the rear wall of the accumulator, wherein the at least one auger comprises flighting;
at least one motor configured to drive the at least one auger to rotate; and
a controller communicatively coupled to the at least one motor, wherein the controller comprises a processor and a memory, and the controller is configured to:
control the at least one motor to drive the at least one auger to rotate in a first direction while the accumulator is being filled; and
control the at least one motor to drive the at least one auger to rotate in a second direction, opposite the first direction, while the accumulator is being unloaded.

2. The accumulator assembly of claim 1, wherein the flighting of the at least one auger is tapered.

3. The accumulator assembly of claim 1, wherein the flighting of the at least one auger is non-continuous.

4. The accumulator assembly of claim 1, wherein a pitch of the flighting of the at least one auger is variable.

5. The accumulator assembly of claim 1, comprising a sensor configured to output a sensor signal indicative of pressure on the at least one auger, wherein the sensor is communicatively coupled to the controller, and the controller is configured to:
receive the sensor signal; and
control the at least one motor based on the pressure on the at least one auger.

6. The accumulator assembly of claim 1, wherein the at least one auger comprises a first auger and a second auger, the at least one motor comprises a first motor and a second motor, the first motor is configured to drive the first auger to rotate, the second motor is configured to drive the second auger to rotate, and the controller is configured to control the first and second motors independently of one another.

7. The accumulator assembly of claim 1, wherein the controller is configured to control the at least one motor to drive the at least one auger to rotate at a plurality of speeds.

8. The accumulator assembly of claim 7, wherein the controller is configured to:
determine a determined speed of the plurality of speeds based on at least one property of the agricultural product; and
control the at least one motor to drive the at least one auger to rotate at the determined speed.

9. The accumulator assembly of claim 7, wherein the controller is configured to:
determine a determined speed of the plurality of speeds based on a distribution of the agricultural product within the accumulator; and
control the at least one motor to drive the at least one auger to rotate at the determined speed.

10. The accumulator assembly of claim 1, wherein the at least one auger is disposed within the accumulator at an angle.

11. An accumulator assembly for an agricultural harvester, comprising:
an accumulator configured to receive agricultural product from a header of the agricultural harvester via an inlet portion of the accumulator, wherein the accumulator comprises a front wall, a rear wall, and a pair of side walls;
at least one auger disposed within the accumulator and extending longitudinally between the front wall and the rear wall of the accumulator, wherein the at least one auger comprises flighting;
at least one motor configured to drive the at least one auger to rotate;
a plurality of conveying rollers positioned at a bottom of the accumulator, wherein
the plurality of conveying rollers is configured to convey the agricultural product toward a
conveying system, the plurality of conveying rollers is oriented at an angle, and the at least one auger is positioned above the plurality of conveying rollers and oriented at the angle of the plurality of conveying rollers; and
a controller communicatively coupled to the at least one motor, wherein the controller comprises a processor and a memory, and the controller is configured to:
control the at least one motor to drive the at least one auger to rotate in a first direction while the accumulator is being filled; and
control the at least one motor to drive the at least one auger to rotate in a second direction, opposite the first direction, while the accumulator is being unloaded.

12. The accumulator assembly of claim 11, wherein the at least one auger has a front end and a rear end, and the flighting of the at least one auger is tapered such that the flighting of the front end of the at least one auger has a smaller diameter than the flighting of the rear end of the at least one auger.

13. The accumulator assembly of claim 11, further comprising a sensor configured to output a sensor signal indicative of a property of the agricultural product, wherein the controller is configured to:
receive the sensor signal; and
control the at least one motor to drive the at least one auger to rotate based on the property of the agricultural product.

14. The accumulator assembly of claim 11, wherein the controller is configured to:
determine a determined speed based on at least one property of the agricultural product;
control the at least one motor to drive the at least one auger to rotate at the determined speed.

15. The accumulator assembly of claim 11, wherein the controller is configured to:
determine a determined speed based on a distribution of the agricultural product within the accumulator; and
control the at least one motor to drive the at least one auger to rotate at the determined speed.

16. The accumulator of claim 11, further comprising an upper-level sensor and a low-level sensor communicatively coupled to the controller, wherein the upper-level sensor is configured to output an upper-level sensor signal indicative of detection of the agricultural product above an upper-level, the low-level sensor is configured to output a low-level sensor signal indicative of detection of the agricultural product below a low-level, and the controller is configured to:
control the at least one motor to drive the at least one auger to rotate in the first direction in response to detection of the agricultural product below the low-level; and
control the at least one motor to drive the at least one auger to rotate in the second direction in response to detection of the agricultural product above the upper-level.

17. The accumulator assembly of claim 11, wherein the at least one auger comprises a first auger with clockwise flighting and a second auger with counterclockwise flighting, the at least one motor comprises a first motor and a second motor, the first motor is configured to drive the first auger to rotate, the second motor is configured to drive the second auger to rotate, and the controller is configured to control the first and second motors independently of one another.

18. A control system for an accumulator assembly, comprising:
a controller comprising a processor and a memory, wherein the controller is configured to:
control a first motor to drive a first auger to rotate in a respective first direction while an accumulator of the accumulator assembly is being filled and to rotate in a respective second direction, opposite the respective first direction, while the accumulator is being unloaded; and
control a second motor to drive a second auger to rotate in a respective first direction while the accumulator is being filled and to rotate in a respective second direction, opposite the respective first direction, while the accumulator is being unloaded;
wherein the controller is configured to control the first and second motors independently of one another.

19. The control system of claim 18, wherein the controller is configured to:
determine a first determined speed based on a distribution of the agricultural product along the first auger within the accumulator;
determine a second determined speed based on a distribution of the agricultural product along the second auger within the accumulator;
control the first motor to drive the first auger to rotate at the first determined speed; and
control the second motor to drive the second auger to rotate at the second determined speed.

20. The control system of claim 18, further comprising:
a first sensor communicatively coupled to the controller and configured to output a first sensor signal indicative of pressure on the first auger;
a second sensor communicatively coupled to the controller and configured to output a second sensor signal indicative of pressure on the second auger;
wherein the controller is configured to:
receive the first sensor signal and the second sensor signal;
control the first motor to rotate the first auger at a first speed based on the pressure on the first auger; and
control the second motor to rotate the second auger at a second speed based on the pressure on the second auger.
